(19) United States
(12) Patent Application Publication
(10) Pub. No.: US 2026/0273416 A1
(43) Pub. Date: Sep. 17, 2026

(54) MULTI-DIMENSIONAL NEURAL OBJECT REPRESENTATIONS OF LARGE-SCALE ASSETS IN GAMING APPLICATIONS

(71) Applicants: Sony Interactive Entertainment Inc., Tokyo (JP); Sony Interactive Entertainment LLC, San Mateo, CA (US)

(72) Inventors: Jeffrey R. Stafford, Redwood City, CA (US); Joseph Logan Olson, Glendale, CA (US); Nathan Gross, Aliso Viejo, CA (US); Bandaly Azzam, Anaheim Hills, CA (US)

(73) Assignees: Sony Interactive Entertainment Inc., Tokyo (JP); Sony Interactive Entertainment LLC, San Mateo, CA (US)

(21) Appl. No.: 19/080,144

(22) Filed: Mar. 14, 2025

(51) Int. Cl. A63F 13/67; A63F 13/5252; A63F 13/533

(52) U.S. Cl. CPC A63F 13/67; A63F 13/5252; A63F 13/533; A63F 2300/538

(57) ABSTRACT

Multi-dimensional neural object representations can be generated to use as placeholders for large-scale assets in cloud gaming development. For example, a method performed by a cloud server system can involve generating, by a game engine, a rendering of an asset in a gaming application. A virtual camera of the game engine can capture one or more video frames depicting the rendering of the asset. The method can involve generating, based on the video frames, a multi-dimensional neural object representation with a second data size. A first data size of the asset can be larger than the second data size. In response to receiving a request for the asset from a client device, the method can involve providing the multi-dimensional neural object representation of the asset such that the multi-dimensional neural object representation is included in an input to a rendering engine executed by the client device.

### BACKGROUND

Modern game consoles, such as the PlayStation® 5 video game console, are sophisticated machines capable of providing engaging video game and entertainment experiences. A game console helps to streamline the gaming industry by providing a common platform of standardized resources (e.g., hardware and software) for the development, distribution, and execution of video games. In this manner, game developers can optimize their game development for the game console, and provide consumers with a seamless video game experience devoid of concerns about video game compatibility, optimization, or complicated setup with respect to the platform on which the game is run.

A fairly recent development enabled by the proliferation of the Internet is the rise of cloud gaming, in which a video game is executed remotely (e.g., in a remote data center), with gameplay being streamed over the Internet to a user's local client device. More specifically, gaming inputs are transmitted from the client device over the Internet to the cloud executed video game, and the gameplay video generated by the video game is streamed over the Internet to the client device for rendering on a display.

However, while such advantages of the game console ecosystem are afforded for the consumer, because of the proprietary nature of game console hardware, supporting game development can be more complex. The game console needs to be adapted in various ways to accommodate the needs of game developers, or additional specialized hardware needs to be created to enable game development. Furthermore, these game development specialized systems are not easily adapted for cloud-based development.

### BRIEF DESCRIPTION OF THE DRAWINGS

The disclosure may be better understood by reference to the following description taken in conjunction with the accompanying drawings in which:

FIG. 1 illustrates an example block diagram of a computing environment for cloud game development using multi-dimensional neural object representations as asset placeholders, according to an embodiment of the present disclosure.

FIG. 2 illustrates an example block diagram of a user interface of a client device presenting multi-dimensional neural object representations as asset placeholders, according to an embodiment of the present disclosure.

FIG. 3 illustrates an example of a gaming console streaming a gaming application for use in generating multi-dimensional neural object representations as asset placeholders, according to an embodiment of the present disclosure.

FIG. 4 illustrates an example flow for performing cloud game development using multi-dimensional neural object representations as asset placeholders, according to an embodiment of the present disclosure.

FIG. 5 illustrates another example computing environment for cloud game development using multi-dimensional neural object representations as asset placeholders, according to an embodiment of the present disclosure.

FIG. 6 illustrates an example of a computer system suitable for implementing techniques of the present disclosure, according to embodiments of the present disclosure.

In the appended figures, similar components and/or features can have the same reference label.

### DESCRIPTION OF ILLUSTRATIVE EMBODIMENTS

Embodiments of the present disclosure are directed to, among other things, generating multi-dimensional neural object representations to use as placeholders for large-scale assets in cloud gaming development. For example, a client device may access a portion (e.g., digital content such as a game level, an in-game region, etc.) of a gaming application in development, such as by downloading the portion to the client device. The portion may include several assets, such as three-dimensional models, textures, graphics, artwork, sounds, animations, or any other individual pieces (or a combination of individual pieces) of digital content that make up a gaming application. A user may be developing, examining, approving, or otherwise interacting with some aspects of the gaming application, but many or even most of the downloaded assets may be irrelevant for such interaction. For instance, a user may be performing an art review inspecting and/or modifying visual aspects of assets in the gaming application, without substantially interacting with gameplay functions of the gaming application. Thus, to reduce latency in transferring gaming application data and to more efficiently consume computing resources (e.g., due to data sizes), the cloud server system hosting the gaming application can generate multi-dimensional object representations of certain assets to use as placeholder representations when transferring to the client device.

To illustrate, consider the following particular example. A gaming application may include a level set in a building that includes an animated fireplace (e.g., with flickering flames, associated audio, etc.). The level of the gaming application may involve fighting gameplay between player characters inside the building. The player characters may also interact with other assets depicted in the building, such as a chair or a table. A developer or other user may use a client device to test, review, annotate, or otherwise develop the visual appearance of the fireplace. Because the fireplace may not be an interactable asset, development or testing of the fireplace artwork may not involve any modifications or even any interactions with gameplay aspects of the gaming application. But, because other assets or gaming logic for the gameplay assets (or even artwork assets, including the fireplace artwork) may be large in size, such as up to multiple terabytes each, it may take significant amounts of time (e.g., up to hours) for the entire level of the gaming application to be downloaded from the cloud server system and rendered on the client device. Then, the client device may continue to render large-scale gameplay assets while developing or testing the fireplace artwork, further consuming unnecessary computing resources and possibly providing a less than optimally responsive user interface (e.g., one with notable lag).

Thus, rather than transferring large-scale assets as-is to the client device, the cloud server system can instead generate a multi-dimensional neural representation of objects (e.g., assets) depicted in the level of the gaming application. A non-limiting example of a multi-dimensional neural representation can include a Gaussian splat. In some examples, rather than transmitting game data, the cloud server system may transmit a multi-dimensional neural rendering of the entire level (e.g., the building including the fireplace and other assets). In other examples, the cloud server system may transmit a portion of the gaming application with certain assets (e.g., the fireplace) replaced with multi-dimensional neural object representations of the assets. Such multi-dimensional neural object representations, also referred to as neural volumetric renderings, can have the exact dimensions and visual properties of corresponding assets, while having a significantly smaller data size than corresponding assets. In some examples, the multi-dimensional neural object representations used as a placeholder may be identical to the original large-scale asset that is rendered with polygons or voxels. By having the same dimensions and a similar or identical visual appearance, the multi-dimensional neural object representations can be used as placeholders for remote development without negatively affecting the development of other gaming assets, such as unrelated gameplay functions of the gaming application.

The cloud server system can host a game engine used to create and execute the gaming application. The game engine can include a virtual camera that can capture video frames of multi-dimensional assets, such as the fireplace asset. The fireplace asset may have an animation dimension depicting flickering flames, an audio dimension of audio outputting fireplace audio, or any other suitable dimensions. For example, the visual appearance of the fireplace asset may change depending on a time of day within the gaming application. The flames of the fireplace asset may appear relatively brighter within the building during a nighttime compared to a daytime within the gaming application. The virtual camera can be used to capture and record video frames of the fireplace asset from multiple angles and over time.

In addition, the video frames may capture changing characteristics of the different dimensions of the fireplace asset. For example, a first set of video frames can depict the animation of the fireplace asset at nighttime and a second set of the video frames can depict the animation of the fireplace at midday. The video frames captured by the game engine's virtual camera can be used to generate a multi-dimensional neural object representation of the fireplace asset, such as providing the video frames to a trained machine learning model. In some examples, some or all of the assets in the building (e.g., including the building itself) may also be represented via corresponding multi-dimensional neural object representations generated from video frames captured by the virtual camera of the game engine.

Thus, rather than transferring the large-scale assets for the level of the gaming application as-is to the client device, the cloud server system can instead generate placeholder representations for such large-scale assets. In particular, large-scale assets in which the artwork (as opposed to the gameplay interactions) of an asset is being developed, can have corresponding multi-dimensional neural object representations generated by the cloud server system. When transferring to the client device, the cloud server system can replace the artwork assets in the gaming data for the level with corresponding multi-dimensional neural object representations. In some examples, all of the gaming data may be replaced with corresponding multi-dimensional neural object representations. The client device can then render the gaming data that includes the multi-dimensional neural object representations, which may have a significantly smaller data size than the original high-fidelity assets.

Embodiments of the present disclosure can provide several advantages over existing techniques in cloud gaming development. Conventional techniques may involve downloading large-scale polygonal or voxel assets. Downloading the high-fidelity, high-data size gaming data for polygonal or voxel assets may be time-consuming and unnecessary in many development or review situations, particularly when the situations involve the artwork of assets rather than testing gameplay functions. By generating smaller-data size neural object representations based on video frames captured by a virtual camera of a game engine, embodiments described herein can significantly reduce latency involved in transferring portions of a gaming application to a remote client device. The remote client device may consume fewer computing resources by rendering smaller-data size assets (e.g., for asset artwork review) that are visually similar or even identical to the large-scale assets.

In some examples, embodiments described herein can involve using machine learning to generate multi-dimensional neural object representations that can have the same dimensions (e.g., volumetric size), visual properties, audio properties, etc. as the large-scale assets that are rendered with polygons or voxels. The multi-dimensional neural object representations may exactly replicate visual effects, such as lighting or mirror effects from viewing the multi-dimensional neural object representation at different angles or times of day, if such effects were captured by the virtual camera of the game engine. Thus, from a developer's perspective, there may be no visual difference between rendering the multi-dimensional neural object representation versus the large-scale asset.

Further, although the multi-dimensional neural object representations described herein may be generated using video frames captured by a game engine, any platform that can render neural objects may download and render the multi-dimensional neural object representations. For instance, the client device may download and render the multi-dimensional neural object representations described herein within a suitable web browser without using a game engine at all. This can allow for review and annotation of assets (e.g., artwork assets) on devices such as smartphones or tablets that are not specialized for game development.

In the interest of clarity of explanation, the embodiments can be described in connection with development of a video game system including a video game console, such as a virtual gaming console hosted by a cloud server system. However, the embodiments are not limited as such and can similarly apply to any other type of a computer system.

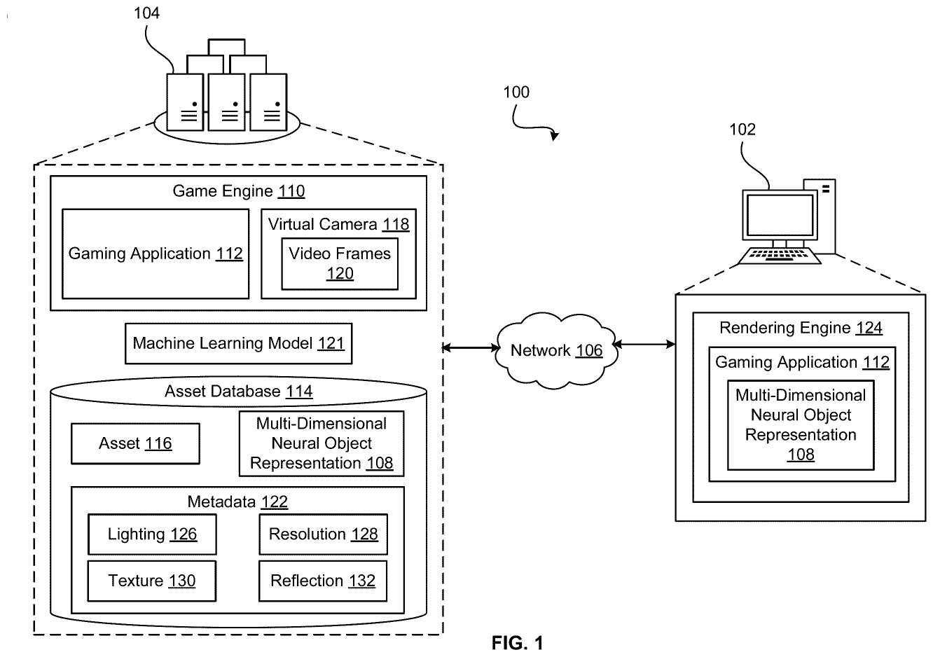

FIG. 1 illustrates an example block diagram of a computing environment 100 for cloud game development using multi-dimensional neural object representations 108 as asset placeholders, according to an embodiment of the present disclosure. The computing environment 100 can include a client device 102 and a cloud server system 104 communicatively coupled via a wireless network 106 (e.g., the Internet). The cloud server system 104 can host a gaming application 112 via a game engine 110. An example of the game engine 110 can be Unreal® Engine. The gaming application 112 may be in development. For example, the client device 102 may be used to access portions of the gaming application 112, such as by modifying, annotating, reviewing, or otherwise interacting with the gaming application 112. To do so, the client device 102 may download a copy of some or all of the gaming application 112 from the cloud server system 104 via the network 106.

The cloud server system 104 may also include an asset database 114 storing assets 116 of the gaming application 112. Assets 116 can be digital content (e.g., data objects) that make up the gaming application 112, such as representations of characters, buildings, vehicles, textures, sounds, animations, props, or any other elements (e.g., individual elements or a combination of elements) of the gaming application 112. Assets 116 may have dimension (e.g., may be two-dimensional or three-dimensional) and may have various attributes, including visual properties. Some assets 116 may be relatively large in order to be rendered with high fidelity. For instance, some assets 116 may have data sizes of terabytes or more.

In cloud gaming development, it may be common for developers to be distributed around the world. Thus, accessing some or all portions of the gaming application 112 to develop the gaming application 112 may involve downloading large-scale assets 116 over significant distances, such as over thousands of miles. In many cases, a developer may work on a portion of the gaming application 112 that includes large-scale assets 116 that may or may not be modified during a development session. For example, the gaming application 112 may be a racecar video game. The racecar setting may include assets 116 such as trees, plants, signage, and the like that may be large-scale assets that are rendered with polygons or voxels. Such assets 116 may not, in some examples, be interactable. For instance, a tree asset may be positioned within a region of the racetrack that is inaccessible to a car driving on the racetrack. A developer or other user working on the gaming application 112 via the client device 102 may wish to review and annotate artwork for the tree asset, and may not be developing other gameplay features of the gaming application. Therefore, it may be a waste of computing resources for the client device 102 to download and fully render other assets or gameplay features, such as interactable cars on the racetrack. If modifications to the tree asset are not directly being made via the client device 102 (e.g., if the user is instead viewing and providing feedback, such as via annotations, for the artwork of the tree asset), it may also be a waste of computing resources to download and fully render the large-scale tree asset.

To reduce latency in developing the gaming application 112, the cloud server system 104 can generate multi-dimensional neural object representations 108 of such large-scale assets 116, particularly for artwork assets under review. In some examples, the multi-dimensional neural object representations 108 can include three-dimensional or four-dimensional (or any dimension) Gaussian splats, but any other suitable neural rendering that has a volume that can occupy a three-dimensional space (e.g., the same three-dimensional space as the asset 116 with the same dimensions) can be used. In contrast with polygonal or voxel rendering of the large-scale asset 116, the multi-dimensional neural object representation 108 can instead be a neural rendering that constructs a three-dimensional object from two-dimensional images. The cloud server system 104 can execute a machine learning model 121 to generate the multi-dimensional neural object representations 108. The machine learning model 121 may be, for example, a deep neural network (DNN), but any suitable machine learning model that can generate neural object representations may be used.

The multi-dimensional neural object representations 108 can be visually similar or identical placeholders for the large-scale assets 116 using a virtual camera 118 of the game engine 110. For example, the virtual camera 118 can spin around an asset 116, such as the tree asset, to capture video frames 120 of the asset 116. The video frames 120 can then be used to generate one or more multi-dimensional neural object representations 108, such as providing the video frames 120 as input to the machine learning model 121 executed by the cloud server system 104. In some examples, the virtual camera 118 may only capture video frames 120 that are viewable from the perspective of a playable character (e.g., for a car on the racetrack). In some examples, the video frames 120 may be captured in various scenarios, such as various lighting scenarios or various levels of details. Thus, the resulting visual appearance of the multi-dimensional neural object representation 108 can reflect different lighting scenarios or different levels of detail when rendered by the client device 102. In some examples, the video frames 120 of the asset 116 can be captured on their own against a background. For example, the asset 116 depicted in a video frame 120 can be silhouetted against a background that does not depict other assets in the gaming application 112. The background may be a blank background (e.g., the background pixels may have no value, may have transparency alpha values, or may be a colored background such as a black or a white background). Capturing video frames 120 that depict only the asset 116 without other assets or features in the gaming application 112 can improve the accuracy of subsequent generation of the multi-dimensional neural object representations 108.

A multi-dimensional neural object representation 108 for a corresponding asset 116 can have some or all visual properties in common and may have the same dimensions (e.g., volumetric representation or three-dimensional size) as the asset 116. In some examples, if captured by the virtual camera 118, the multi-dimensional neural object representations 108 may have additional dimensions, such as animated features, such as leaves of the tree blowing in the wind. Other visual effects, such as lighting 126, resolution 128, texture 130, reflection 132 (e.g., mirroring), audio, or the like may also be replicated as additional dimensions in the multi-dimensional neural object representations 108 if captured by the virtual camera 118. For example, the multi-dimensional neural object representations 108 may have a different visual appearance in a daytime mode of the gaming application 112 versus a nighttime mode, which may mirror the visual appearance of the asset 116 in the daytime mode or nighttime mode.

As the multi-dimensional neural object representations 108a may have volume (e.g., the same volume as the asset 116), other objects in the gaming application 112 may collide with the multi-dimensional neural object representations 108. In some examples, the multi-dimensional neural object representations 108 may not have some or all of the same interactable features as their corresponding large-scale asset 116, but can faithfully represent the large-scale asset 116 in a rendering of the gaming application 112 (e.g., when rendered by the client device 102).

The different characteristics, settings, or dimensions (e.g., lighting 126, resolution 128, texture 130, reflection 132, or the like) of the multi-dimensional neural object representations 108 can be requested or set by the client device 102, such as in a request for the asset 116. For example, the client device 102 may request that the multi-dimensional neural object representation 108 for an asset 116 be rendered at different resolution levels. Thus, the video frames 120 may capture the asset 116 at a first resolution value and a second resolution value that may be higher than the first resolution value. The video frames 120 can be used to generate a multi-dimensional neural object representation 108 that can reflect either the first resolution value or the second resolution value. For example, when rendered by a rendering engine 124 on the client device 102, the multi-dimensional neural object representation 108 can be displayed at the first resolution value when viewed with a first zoom setting. If the client device 102 “zooms in” on the multi-dimensional neural object representation 108 to a second zoom setting, the rendering of the multi-dimensional neural object representation 108 may then display the second (e.g., higher) resolution value.

The resolution values of the multi-dimensional neural object representation 108 may exactly represent the resolution values of the asset 116 when captured in video frames 120 by the virtual camera 118. This can allow for precise review of the asset 116 via the multi-dimensional neural object representation 108 on the client device 102, even though the asset 116 itself may not be rendered on the client device 102. Thus, multi-dimensional neural object representations 108 can be used for artwork review to identify issues. For example, asset features such as silhouette mismatch from different resolution values having different silhouettes that may overlap when zooming in or out may be exactly replicated by corresponding multi-dimensional neural object representations 108. Exactly replicating artwork issues in the multi-dimensional neural object representations 108 can allow for issues to be identified and resolved without having to transfer large-scale assets 116 for download to the client device 102.

The multi-dimensional neural object representations 108 can be stored in the asset database 114 in association with corresponding metadata 122. The metadata 122 can indicate the associated large-scale asset 116 and any relevant properties, settings, characteristics, associated values, etc. of the multi-dimensional neural object representations 108, such as lighting 126, resolution 128, texture 130, reflection 132, etc. The metadata 122 may also indicate the type of testing, development, or review that is to be performed on the multi-dimensional neural object representation 108, the type of user (e.g., artwork director, developer, etc.) that will be accessing the multi-dimensional neural object representation 108, or any other relevant information (e.g., as indicated in a request from the client device 102). In some examples, when the cloud server system 104 transmits the multi-dimensional neural object representation 108 to the client device 102, the cloud server system 104 may also transmit the metadata 122. The client device 102 may use the metadata 122 to control display of the multi-dimensional neural object representation 108 (e.g., at the different lighting levels, resolution values, etc.).

In some examples, when a new asset 116 is stored in the asset database 114, the cloud server system 104 may automatically generate one or more multi-dimensional neural object representations 108 for the corresponding asset 116 to also be stored in the asset database 114. In other examples, a multi-dimensional neural object representation 108 may be generated on demand (e.g., in response to a request from the client device 102) and stored in the asset database 114. Future requests for the asset 116 or a representation of the asset 116 may be fulfilled with the stored multi-dimensional neural object representation 108. Depending on the size of the asset 116, generating a lower-data size multi-dimensional neural object representation 108 and transferring the multi-dimensional neural object representation 108 to the client device 102 may still consume fewer computing resources and/or network bandwidth than transferring the large-scale asset 116 to the client device 102. In some examples, the cloud server system 104 may periodically (e.g., during developer or player downtime, such as overnight, after check-in of the asset 116, or by request) generate multi-dimensional neural object representations 108 of some or all assets 116 in the asset database 114. Pre-generating the multi-dimensional neural object representations 108 can further reduce latency, such that future requests for an asset 116 can be automatically fulfilled with a corresponding multi-dimensional neural object representation 108 (e.g., without having to wait for the multi-dimensional neural object representation 108 to be generated).

Thus, in response to receiving a request for an asset 116 from the client device 102, the cloud server system 104 can respond to the request by transferring data files for the corresponding multi-dimensional neural object representation 108 to the client device 102. In some examples, the cloud server system 104 can transfer data files for a requested portion of the gaming application 112 to the client device 102, with the large-scale asset 116 replaced with its corresponding multi-dimensional neural object representation 108. Or, the entire requested portion of the gaming application 112 may be replaced with multi-dimensional neural object representations. The client device 102 may download the transferred data files that include the multi-dimensional neural object representation 108 significantly faster than if the transferred data files included the large-scale asset 116. For instance, because of the relatively low data size of the multi-dimensional neural object representation 108, the multi-dimensional neural object representation 108 may be transferred and downloaded in an email message. The client device 102 may execute a rendering engine 124 to render the transferred and downloaded data files into a presentation of the gaming application 112 that includes the multi-dimensional neural object representation 108. A user of the client device 102, such as a developer or an artwork director, can then view, annotate, modify, or otherwise annotate the portion of the gaming application 112 that includes the multi-dimensional neural object representation 108.

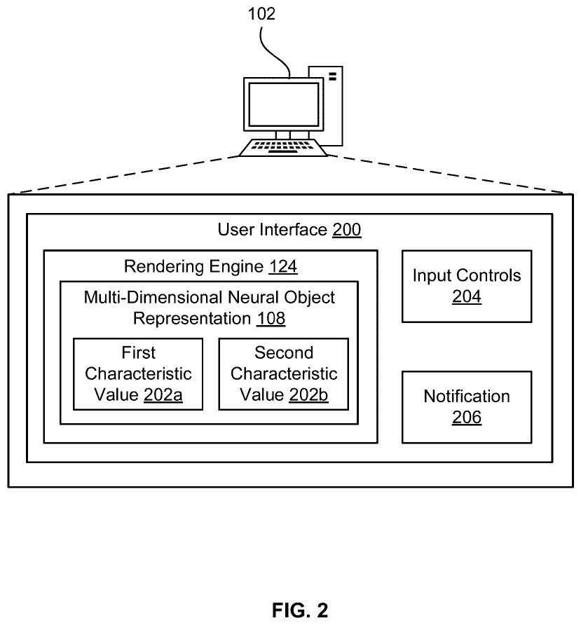

FIG. 2 illustrates an example block diagram of a user interface 200 of the client device 102 of FIG. 1 presenting multi-dimensional neural object representations 108 as asset placeholders, according to an embodiment of the present disclosure. The client device 102 may execute a rendering engine 124 that can present renderings of the multi-dimensional neural object representation 108 via the user interface 200 of the client device 102. In some examples, the rendering engine 124 may be the same engine as the game engine 110 hosted by the cloud server system 104. In other examples, the rendering engine 124 may be any engine that can render the features of the transferred portion of the gaming application 112, including a web browser engine. For example, a large-scale game engine 110 such as Unreal® Engine may not be necessary to render the multi-dimensional neural object representation 108. The client device 102 may instead use a lighter weight rendering engine 124 such as a web browser engine, thus further conserving computing resource usage of the client device 102.

The client device 102 may receive input controls 204 from a user, such as an artwork director or a developer of the gaming application 112. The input controls 204 may control display of the multi-dimensional neural object representation 108. For example, the input controls 204 may include a selection of characteristic values 202a-b of the multi-dimensional neural object representation 108 to display or output, such as lighting, resolution, reflectivity, audio, etc. The input controls 204 may control the angle or orientation at which the multi-dimensional neural object representation 108 is viewed via the user interface 200. Because the multi-dimensional neural object representation 108 can be visually similar or identical to its corresponding asset 116, the orientations at which the multi-dimensional neural object representation 108 can be viewed can be visually similar or identical as renderings of the corresponding asset 116 at the same orientations.

The input controls 204 may also involve annotations that are to be overlaid on the display of the multi-dimensional neural object representation 108. In some examples, the multi-dimensional neural object representation 108 with the overlaid annotations can be transferred to the cloud server system 104 for storage or to any other device, such as a device used by a developer to modify the corresponding asset 116. The input controls 204 may also include requests to update characteristic values 202a-b of the multi-dimensional neural object representation 108, such as requesting additional dimensions (e.g., animation, audio, etc.) to be output via the user interface 200. The client device 102 can transmit a request (e.g., to the cloud server system 104 of FIG. 1). Then, the client device 102 may receive an updated version of the multi-dimensional neural object representation 108 that may depict or otherwise include the requested additional dimensions.

The client device 102 may be any suitable computing device that can execute a rendering engine 124 capable of rendering a multi-dimensional neural object representation 108. In some examples, the client device 102 may be or may include a smartphone or a virtual reality headset with virtual reality control devices. The input controls 204 may be received via the smartphone, the virtual reality headset, the virtual reality control devices, etc. For example, the orientation at which the multi-dimensional neural object representation 108 is presented via the user interface 200 can depend on a direction or angle at which a user is using the virtual reality headset to view the multi-dimensional neural object representation 108. Or, if the client device 102 is a smartphone, the orientation at which the multi-dimensional neural object representation 108 is presented via the user interface 200 can depend on the positioning of the smartphone. For example, a smartphone may have six degrees of freedom (e.g., x-axis, y-axis, z-axis, pitch, yaw, and roll) that can be detected as input controls 204 for viewing the multi-dimensional neural object representation 108.

In some examples, the characteristic values 202a-b can be resolution settings for viewing the multi-dimensional neural object representation 108. The resolution settings can be controlled via the input controls 204 received from the user. For example, the first characteristic value 202a can involve a first resolution displayed by the user interface 200. Then, the client device 102 may receive an input control 204 to zoom into the multi-dimensional neural object representation 108. The rendering engine 124 can update the rendering to depict the multi-dimensional neural object representation 108 at a second characteristic value 202b (e.g., a second, higher resolution). The second resolution may be the highest resolution at which the multi-dimensional neural object representation 108 was generated (e.g., and captured for the corresponding asset 116 via video frames 120). Thus, it may not be possible to zoom in any further into the multi-dimensional neural object representation 108 displayed via the user interface 200. If additional input controls 204 are received that request further zooming in, the client device 102 may generate and present a notification 206 via the user interface 200 indicating that the current resolution is the highest possible resolution for the asset 116 in the gaming application 112.

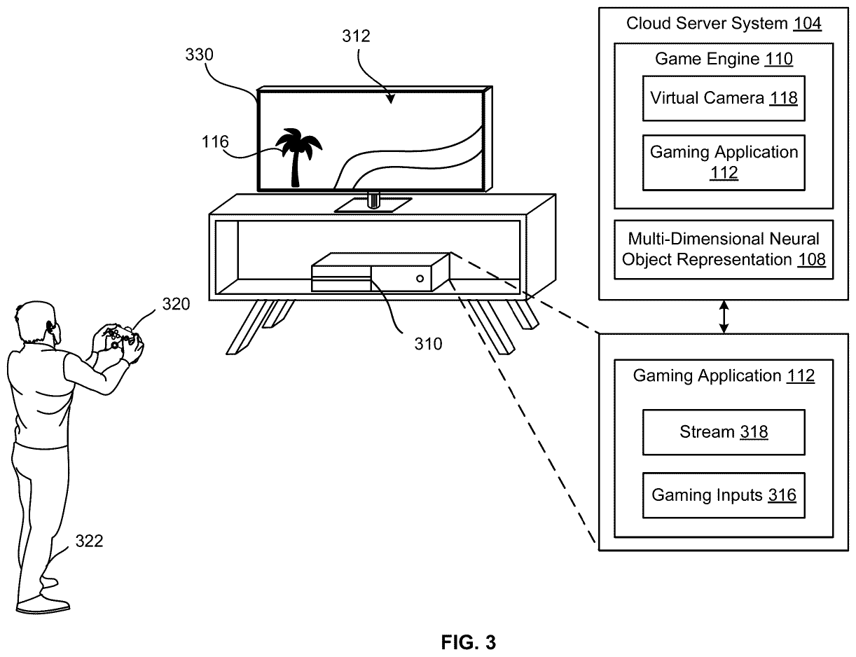

FIG. 3 illustrates an example of a gaming console 310 streaming a gaming application 112 for use in generating multi-dimensional neural object representations 108 as asset placeholders, according to an embodiment of the present disclosure. In some examples, the gaming console 310 may be part of or communicatively coupled to the client device 102 of FIGS. 1-2. Gaming console 310 can be communicatively coupled to a video game controller 320 via an input port and a display port 330 via an output port. The gaming console 310 can also be communicatively coupled to a backup system, such as cloud server system 104, via a network port. Gaming console 310 can be communicatively coupled with a video game controller 320 (e.g., over a wireless network) and with display 330 (e.g., over a communication bus). A user 322, such as a video game player, can operate video game controller 320 to interact with gaming console 310. These interactions can include playing a gaming application 112 (e.g., a video game application) that is presented on display 330 or interacting with other applications of gaming console 310 (e.g., with a content application that can stream content, such as videos, articles, images, social media feeds, podcasts, audiobooks, email, messages, or any other content from an online content source or to play or otherwise present storage from the local storage of gaming console 310).

The gaming console 310 includes a processor and a memory (e.g., a non-transitory computer-readable storage medium) storing computer-readable instructions that can be executed by the processor and that, upon execution of the processor, cause the gaming console 310 to perform operations related to various applications. In particular, the computer-readable instructions can correspond to program codes for the various applications of the gaming console 310, including the gaming application 112.

A video game application, such as gaming application 112, generally represents a computer application executable to present video game content, receive user interaction with the video game content, and accordingly update the video game content. Further, other applications can be likewise included in the gaming console 310, such as a chat application, media application, etc. the availability of the gaming application 112, media application, and/or other type of computer application to the user 322 via the gaming console 310 can depend on a user identifier of the user 322 (e.g., upon a login to the gaming console 310, the availability of the computer applications can depend on the user identifier used in the login).

The video game controller 320 is an example of an input device. The video game controller 320 may allow the user 322 to interact with one or more GUIs presented by the gaming console 310 on the display 330. For example, using one or more directional control inputs (e.g., a joystick and/or a directional pad) the user 322 can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 322 to interact with the GUIs using various voice commands. As another example, a camera may allow the user 322 to interact with the GUIs using various gesture commands.

Upon an execution of the gaming application 112 by the gaming console 310, a rendering process of the gaming console 310 presents a stream 318 of video game content 312 on the display 330. For example, the video game content 312 can depict a rendering of an asset 116, such as a tree asset, of the gaming application 112. The video game content 312 may be rendered by a game engine 110 of the cloud server system 104 and transmitted as the stream 318 to the gaming console 310, which may present the stream 318 via the display 330. The user 322 may provide gaming inputs 316 to control rendering of the gaming application 112 by the game engine 110. For example, the gaming inputs 316 can be transmitted by the gaming console 310 to the cloud server system 104 to control the view of the virtual camera 118. The virtual camera 118 may capture video frames that are transmitted to the gaming console 310 as the stream 318.

In some examples, the stream 318 of the gaming application 112 can be stored and used by the cloud server system 104 to generate the multi-dimensional neural object representation 108. Thus, the multi-dimensional neural object representation 108 can be generated from views (e.g., video frames) of the asset 116 that originated from user gameplay or developer gameplay. In other examples, the cloud server system 104 may automatically execute the virtual camera 118 to capture video frames of the asset 116 (e.g., at different angles, times of day, etc.) to be used in generating the multi-dimensional neural object representation 108.

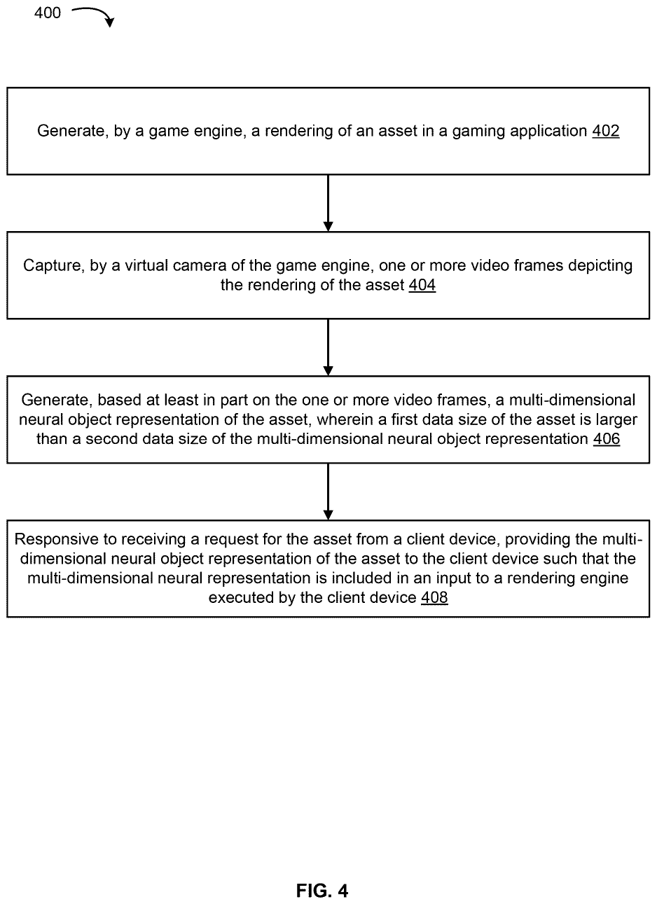

FIG. 4 illustrates an example flow 400 for performing cloud game development using multi-dimensional neural object representations as asset placeholders, according to an embodiment of the present disclosure. The operations of flow 400 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, the flow 400 can include operation 402, which involves a cloud server system generating, by a game engine, a rendering of an asset in a gaming application. In some examples, a client device may remotely access the game engine, such as to interact with or execute the gaming application. For example, the client device may stream content (e.g., the rendering of the asset) from the cloud server system. The client device may transmit gaming inputs or control inputs to the cloud server system. The game engine may update the rendering of the asset streamed to the client device based on the gaming inputs from the client device.

In an example, the flow 400 can include operation 404, which involves the cloud server system capturing, by a virtual camera of the game engine, one or more video frames depicting the rendering of the asset. In some examples, the rendering of the asset may be a first rendering. Capturing the one or more video frames can involve capturing, in a first video frame of the one or more video frames, a first value of a characteristic of the asset. Then, in a second video frame of the one or more video frames, a second value of the characteristic of the asset can be captured. The characteristic may include, for example, a time of day, a lighting setting, a reflection setting, or a texture setting. In some examples, the characteristic may be a resolution setting. In some examples, the client device remotely accessing the game engine may involve the cloud server system receiving, from the client device, a motion path (e.g., via the control inputs) for the virtual camera through a virtual scene of the gaming application. The control inputs may also include at least two angles for the motion path of the virtual camera. In some examples, the one or more video frames may be captured based on the control inputs by at least limiting a first field of view of a motion path for the virtual camera to a second field of view of a video game player of the gaming application during execution of the gaming application by the client device.

In an example, the flow 400 can include operation 406, which involves the cloud server system generating, based at least in part on the one or more video frames, a multi-dimensional neural object representation of the asset. A first data size of the asset can be larger than a second data size of the multi-dimensional neural object representation. In some examples, the multi-dimensional neural object representation can have a same set of dimensions and at least one visual property in common with the asset. In some examples, the multi-dimensional object representation can include at least four dimensions. The at least four dimensions can include at least one of an audio dimension, a lighting dimension, an animation dimension, or a resolution dimension. In some examples, the multi-dimensional neural object representation may also include one or more additional assets depicted in the virtual scene (e.g., streamed to the client device). In some examples, the multi-dimensional neural object representation may be generated based at least in part on a type of user of the client device (e.g., an artwork director, a developer, etc.) or on a type of use of the multi-dimensional neural object representation on the client device (e.g., an art review, an asset development, etc.). In some examples, the multi-dimensional neural object representation may be generated while (e.g., substantially simultaneously to) the game engine is generating the rendering of the asset in the gaming application.

In an example, the flow 400 can include operation 408, which involves the cloud server system, responsive to receiving a request for the asset from a client device, providing the multi-dimensional neural object representation of the asset such that the multi-dimensional neural representation is included in an input to a rendering engine executed by the client device. If the one or more video frames captured multiple values of a characteristic (e.g., a time of day, a lighting setting, a reflection setting, a texture setting, etc.) for the asset, the rendering engine can render the multi-dimensional neural object representation to depict the first value and the second value of the characteristic. For example, the multi-dimensional neural object representation can depict reflectivity of the asset, lighting changes due to viewing the asset (e.g., the multi-dimensional neural object representation) at different angles, etc.

In some examples, the characteristic may be a resolution setting. For example, the one or more video frames may depict the asset at a first resolution and a second resolution. The client device may render the multi-dimensional neural object representation at the first resolution or the second resolution, such as based on a user zooming in or out of the rendering. If user input is received by the client device that zooms too far into the multi-dimensional neural object representation (e.g., farther than zooming capabilities for viewing the asset when rendered by the game engine), the client device may generate a notification indicating that the zoom (e.g., a requested third value for the resolution setting) is not supported by the game engine.

In some examples, the client device may generate the second rendering that depicts the multi-dimensional neural object representation at a first orientation (e.g., viewed at a first angle). A user, such as a developer or a player, can provide movement input to the client device (e.g., indicating an adjustment to a viewing angle within the second rendering). The client device can then update the second rendering to depict the multi-dimensional neural object representation at a second orientation based on the movement input. This updated second rendering may correspond (e.g., exactly mirror) a depiction of the asset at the second orientation if the asset was rendered by the game engine. Thus, the multi-dimensional neural object representation can be interactively viewed via the client device in the same manner as the asset when rendered by the game engine, without having to stream gaming data from the game engine to the client device.

In some examples, a rendering of the multi-dimensional neural object representation is presented at a user interface of the client device by the rendering engine. A user of the client device may provide an input annotating the multi-dimensional neural object representation. Thus, the annotation received by the client device can be presented as an overlay on the rendering multi-dimensional neural object representation on the user interface. In some examples, the user interface of the client device can be used by the user to input a request to change a value of a characteristic of the asset or the multi-dimensional neural object representation. The client device can transmit the request to the cloud server system. The cloud server system may receive the request and, in response, may update the multi-dimensional neural object representation to include, reflect, display, or otherwise incorporate the changed value of the characteristic of the asset. For example, the request may be to depict the asset at a different lighting level or a different resolution. The updated multi-dimensional neural object representation may be a representation of the asset at the different lighting level or different resolution.

In some examples, requests received from the client device can include a request specifying a fourth dimension of the multi-dimensional neural object representation (e.g., when the multi-dimensional neural object representation includes at least four dimensions, such as a three-dimensional volume and an additional dimension). In some examples, the multi-dimensional neural object representation is presented at the client device via the rendering engine based on control inputs received by the client device comprising an x-axis input, a y-axis input, a z-axis input, a pitch input, a yaw input, and a roll input (e.g., six degrees of freedom). For example, the client device may be a smartphone, and the smartphone may be positioned via the six degrees of freedom to control the view of the multi-dimensional neural object representation on the user interface.

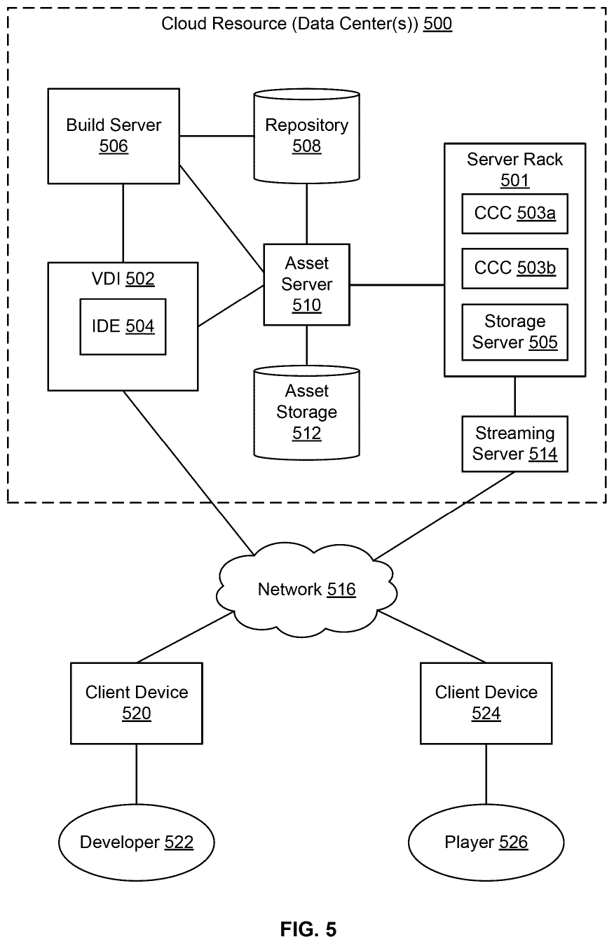

FIG. 5 illustrates another example computing environment for cloud game development using multi-dimensional neural object representations as asset placeholders, according to an embodiment of the present disclosure. In the illustrated implementation, a cloud resource 500 having cloud processing and cloud storage resources is provided. The cloud resource 500 can be an example of the cloud server system 104 of FIGS. 1-3. In various implementations, the illustrated systems can be implemented in one or more data centers, connected over the Internet. For example, a server rack 501 can be implemented in a data center, and a given console compute card 503a can be assigned to a player 526 and client device 524 for gameplay of a given console video game title. The client device 524 can be an example of the client device 102 of FIGS. 1-3. The console compute card 503b will be loaded with the video game title, and gameplay will be streamed over network 516 (including the Internet) to the player's client device 524. In some implementations, a streaming server 514 is implemented to manage video streaming to the client device 524, for example, to optimize the video stream for network conditions, the player's hardware capabilities, etc.

In some implementations, a cloud-based game development platform is enabled by using the console compute cards in conjunction with game development systems. For example, a virtual desktop infrastructure 502 can be implemented that allows a developer 522 operating their client device 520 to access over network 516 a virtual desktop providing cloud-hosted tools for game development, such as an integrated development environment 504 or other development software (e.g., 3D rendering/animation software, etc.). The client device 520 may be an example of the client device 102 of FIGS. 1-3. An asset server 510 manages access to an asset storage 512 containing game assets such as textures, rigs, animations, audio, etc. A build server 506 manages access to various builds of video games, stored to a repository 508. The build server 506 can manage access to source code files, and compile source code into executables for deployment onto the console compute cards.

When a given executable build of a video game is executed by a console compute card, then the gameplay of the game build can be cloud streamed as previously described. For example, the player 526 may be a quality assurance (QA) tester or alpha/beta tester involved in supporting the development of the video game. In this manner, a cloud environment for end-to-end game development of console-based games is enabled, whereby game assets and builds are developed in the cloud, and testing on console-equivalent hardware is also cloud-based. This enables development teams and individuals, including software developers, artists, QA testers, project managers, etc. to engage and collaborate in game development activities remotely.

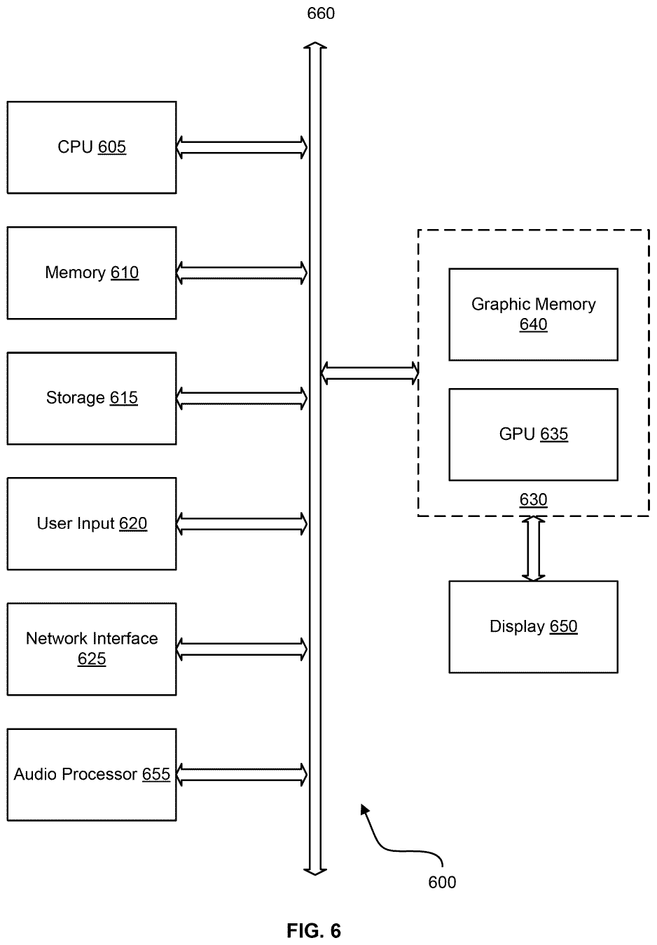

FIG. 6 illustrates an example of a computer system 600 suitable for implementing techniques of the present disclosure, according to embodiments of the present disclosure. The computer system 600 represents, for example, a video game system, a backend set of servers, or other types of a computer system. The computer system 600 includes a central processing unit (CPU) 605 for running software applications and optionally an operating system. The CPU 605 may be made up of one or more homogeneous or heterogeneous processing cores. Memory 610 stores applications and data for use by the CPU 605. Storage 615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 620 communicate user inputs from one or more users to the computer system 600, examples of which may include keyboards, mice, thumbsticks, touch pads, touch screens, still or video cameras, and/or microphones. Network interface 625 allows the computer system 600 to communicate with other computer systems via an electronic communications network and may include wired or wireless communication over local area networks and wide area networks such as the Internet. An audio processor 655 is adapted to generate analog or digital audio output from instructions and/or data provided by the CPU 605, memory 610, and/or storage 615. The components of computer system 600, including the CPU 605, memory 610, data storage 615, user input devices 620, network interface 625, and audio processor 655 are connected via one or more data buses 660.

A graphics subsystem 630 is further connected with the data bus 660 and the components of the computer system 600. The graphics subsystem 630 includes a graphics processing unit (GPU) 635 and graphics memory 640. The graphics memory 640 includes a display memory (e.g., a frame buffer) used for storing pixel data for each pixel of an output image. The graphics memory 640 can be integrated in the same device as the GPU 635, connected as a separate device with the GPU 635, and/or implemented within the memory 610. Pixel data can be provided to the graphics memory 640 directly from the CPU 605. Alternatively, the CPU 605 provides the GPU 635 with data and/or instructions defining the desired output images, from which the GPU 635 generates the pixel data of one or more output images. The data and/or instructions defining the desired output images can be stored in the memory 610 and/or graphics memory 640. In an embodiment, the GPU 635 includes 3D rendering capabilities for generating pixel data for output images from instructions and data defining the geometry, lighting, shading, texturing, motion, and/or camera parameters for a scene. The GPU 635 can further include one or more programmable execution units capable of executing shader programs.

The graphics subsystem 630 periodically outputs pixel data for an image from the graphics memory 640 to be displayed on the display device 650. The display device 650 can be any device capable of displaying visual information in response to a signal from the computer system 600, including CRT, LCD, plasma, and OLED displays. The computer system 600 can provide the display device 650 with an analog or digital signal.

In accordance with various embodiments, the CPU 605 is one or more general-purpose microprocessors having one or more processing cores. Further embodiments can be implemented using one or more CPUs 605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising, by a cloud server system:
generating, by a game engine, a rendering of an asset in a gaming application;
capturing, by a virtual camera of the game engine, one or more video frames depicting the rendering of the asset;
generating, based at least in part on the one or more video frames, a multi-dimensional neural object representation of the asset, wherein a first data size of the asset is larger than a second data size of the multi-dimensional neural object representation; and
responsive to receiving a request for the asset from a client device, providing the multi-dimensional neural object representation of the asset to the client device such that the multi-dimensional neural object representation is included in an input to a rendering engine executed by the client device.

2. The method of claim 1, wherein the multi-dimensional neural object representation has at least one visual property in common with the asset.

3. The method of claim 1, wherein the rendering is a first rendering, and wherein capturing the one or more video frames of the asset further comprises:
capturing, in a first video frame of the one or more video frames, a first value of a characteristic of the asset; and
capturing, in a second video frame of the one or more video frames, a second value of the characteristic of the asset,
wherein the rendering engine of the client device is configured to generate a second rendering of the multi-dimensional neural object representation that comprises a depiction of the asset including the first value and the second value of the characteristic.

4. The method of claim 3, wherein the characteristic comprises at least one of a time of day, a lighting setting, a reflection setting, or a texture setting.

5. The method of claim 3, wherein the characteristic comprises a resolution setting, and wherein a notification is presented at the client device indicating that a requested third value for the resolution setting is not supported by the game engine.

6. The method of claim 1, wherein a second rendering is generated by the client device that depicts the multi-dimensional neural object representation at a first orientation, and wherein the second rendering is updated, based at least in part on a movement input received from a user, at the client device to depict the multi-dimensional neural object representation at a second orientation, wherein the updated second rendering depicting the multi-dimensional neural object representation at the second orientation corresponds to a depiction of the asset at the second orientation when rendered by the game engine.

7. The method of claim 1, wherein the multi-dimensional neural object representation comprises at least four dimensions, and wherein the at least four dimensions comprise at least one of an audio dimension, a lighting dimension, an animation dimension, or a resolution dimension.

8. The method of claim 1, wherein the game engine is remotely accessed by the client device to control the virtual camera capturing the one or more video frames depicting the rendering of the asset.

9. The method of claim 8, wherein the client device remotely accessing the game engine further comprises:
receiving, from the client device, a motion path for the virtual camera through a virtual scene of the gaming application,
wherein the multi-dimensional neural object representation can further comprise one or more additional assets depicted in the virtual scene.

10. A system comprising:
one or more processors; and
one or more memories storing executable instructions that, upon execution by the one or more processors, cause the system to perform operations to:
generate, by a game engine, a rendering of an asset in a gaming application;
capture, by a virtual camera of the game engine, one or more video frames depicting the rendering of the asset;
generate, based at least in part on the one or more video frames, a multi-dimensional neural object representation of the asset, wherein a first data size of the asset is larger than a second data size of the multi-dimensional neural object representation; and
responsive to receiving a request for the asset from a client device, provide the multi-dimensional neural object representation of the asset to the client device such that the multi-dimensional neural object representation is included in an input to a rendering engine executed by the client device.

11. The system of claim 10, wherein the one or more memories further comprise instructions that are executable by the one or more processors to cause the system to capture the one or more video frames based at least in part on a control input received from the client device.

12. The system of claim 11, wherein the control input comprises at least two angles for a motion path of the virtual camera.

13. The system of claim 11, wherein the one or more memories further comprise instructions that are executable by the one or more processors to cause the system to capture the one or more video frames based at least in part on the control input by at least limiting a first field of view of a motion path for the virtual camera to a second field of view of a video game player of the gaming application during execution of the gaming application by the client device.

14. The system of claim 10, wherein to the one or more memories further comprise instructions that are executable by the one or more processors to cause the system to generate the multi-dimensional neural object representation based at least in part on a type of user of the client device or on a type of use of the multi-dimensional neural object representation on the client device.

15. The system of claim 10, wherein the one or more memories further comprise instructions that are executable by the one or more processors to cause the system to generate the multi-dimensional neural object representation while the game engine is generating the rendering of the asset in the gaming application.

16. The system of claim 10, wherein the a rendering of the multi-dimensional neural object representation is presented at a user interface of the client device by the rendering engine, and wherein an annotation received by the client device is presented as an overlay on the rendering of the multi-dimensional neural object representation on the user interface.

17. The system of claim 10, wherein the one or more memories further comprise instructions that are executable by the one or more processors to cause the system to:
receive, from the client device, a request to change a value of a characteristic of the asset; and
in response to receiving the request to change the value of the characteristic, update the multi-dimensional neural object representation to comprise the changed value of the characteristic of the asset.

18. The system of claim 10, wherein the multi-dimensional neural object representation comprises at least four dimensions, and wherein one or more memories further comprise instructions that are executable by the one or more processors to cause the system to generate the multi-dimensional neural object representation based at least in part on a request from the client device specifying a fourth dimension of the at least four dimensions.

19. The system of claim 10, wherein the multi-dimensional neural object representation is presented at the client device via the rendering engine based on control inputs received by the client device comprising an x-axis input, a y-axis input, a z-axis input, a pitch input, a yaw input, and a roll input.

20. A computer-readable storage medium storing computer-executable instructions that, when executed by one or more processors, cause operations comprising:
generating, by a game engine, a rendering of an asset in a gaming application;
capturing, by a virtual camera of the game engine, one or more video frames depicting the rendering of the asset;
generating, based at least in part on the one or more video frames, a multi-dimensional neural object representation of the asset, wherein a first data size of the asset is larger than a second data size of the multi-dimensional neural object representation; and
responsive to receiving a request for the asset from a client device, providing the multi-dimensional neural object representation of the asset to the client device such that the multi-dimensional neural object representation is included in an input to a rendering engine executed by the client device.
